(19) United States
(12) Patent Application Publication
(10) Pub. No.: US 2025/0390011 A1
(43) Pub. Date: Dec. 25, 2025

(54) LIGHT SOURCE MODULE AND PROJECTOR

(71) Applicant: QISDA CORPORATION, Taoyuan City (TW)

(72) Inventors: Jia-Ming Zhang, Taichung City (TW); Ching-Tze Huang, Taoyuan City (TW)

(73) Assignee: QISDA CORPORATION, Taoyuan City (TW)

(21) Appl. No.: 19/014,243

(22) Filed: Jan. 9, 2025

(30) Foreign Application Priority Data
Jun. 21, 2024 (CN) 202410809296.5

(51) Int. Cl. G03B 21/20

(52) U.S. Cl. CPC G03B 21/2013; G03B 21/2046; G03B 21/2066; G03B 21/2073

(57) ABSTRACT

A light source module includes a plurality of light components, and appropriately configured dichroic mirrors, polarizing dichroic mirrors and half-wave plate structures. The configuration allows light emitted by the plurality of light components to overlap to provide a light output configuration. For example, each of two light components has two groups of light-emitting units that emit light to two configuration areas of the light output configuration respectively. For another example, light emitted by a first light component and a group of light-emitting units of a second light component is guided to a first configuration area of the light output configuration, and light emitted by a third light component and another group of light-emitting units of the second light component is guided to a second configuration area of the light output configuration. A projector includes a projection lens, a light modulation module, and the above light source module.

### BACKGROUND OF THE INVENTION

### 1. Field of the Invention

The present invention relates to a light source module and a projector, and more particularly to a light source module having a plurality of light components and a projector having the light source module.

### 2. Description of the Prior Art

If a laser projector using a single RGB laser component needs to increase the brightness, the number of RGB laser components must be increased, which will inevitably increase the size of the light source module. Furthermore, the RGB laser component usually uses multiple laser units to emit R, G, and B color light (i.e., red light, green light, and blue light). For a single RGB laser component, its overall color uniformity is limited. Therefore, how to configure multiple RGB laser light components to avoid excessively increasing the size of the light source module of the laser projector and reducing the overall uniformity of light output provided by the light source module will be a problem.

### SUMMARY OF THE INVENTION

In view of the problems in the prior art, an objective of the invention is to provide a light source module, which uses dichroic mirrors to overlap the light emitted by groups of light-emitting units of different light components.

A light source module of an embodiment according to the invention is used to provide a light output configuration. The light output configuration includes a first configuration area and a second configuration area. The light source module includes a first light component, a second light component, a first dichroic mirror, and a second dichroic mirror. The first light component includes a first group of light-emitting units and a second group of light-emitting units. The second light component includes a third group of light-emitting units and a fourth group of light-emitting units. Light emitted by the first group of light-emitting units and light emitted by the third group of light-emitting units emit are the same in color. Light emitted by the second group of light-emitting units and light emitted by the fourth group of light-emitting units are the same in color. The first dichroic mirror is disposed corresponding to the first group of light-emitting units, the fourth group of light-emitting units, and the first configuration area. The light emitted by the first group of light-emitting units is reflected by the first dichroic mirror to reach the first configuration area. The light emitted by the fourth group of light-emitting units passes through the first dichroic mirror to reach the first configuration area. The second dichroic mirror is disposed corresponding to the second group of light-emitting units, the third group of light-emitting units, and the second configuration area. The light emitted by the second group of light-emitting units is reflected by the second dichroic mirror to reach the second configuration area. The light emitted by the third group of light-emitting units passes through the second dichroic mirror to reach the second configuration area. Thereby, the first light component and the second light component can be easily configured compactly, and the light source module can provide similar light emission compositions to the first configuration area and the second configuration area, improving the light uniformity.

Another objective of the invention is to provide a light source module, which uses dichroic mirrors, polarizing dichroic mirrors, and half-wave plate structures to overlap the light emitted by groups of light-emitting units of different light components.

A light source module of an embodiment according to the invention is used to provide a light output configuration. The light output configuration includes a first configuration area and a second configuration area. The light source module includes a first light component, a second light component, a third light component, a first dichroic mirror, a second dichroic mirror, a first polarizing dichroic mirror, a second polarizing dichroic mirror, a first half-wave plate structure, and a second half-wave plate structure. The first light component includes a first group of light-emitting units and a second group of light-emitting units. The second light component includes a third group of light-emitting units and a fourth group of light-emitting units. The third light component includes a fifth group of light-emitting units and a sixth group of light-emitting units. Light emitted by the first group of light-emitting units, light emitted the third group of light-emitting units, and light emitted by the fifth group of light-emitting units are the same in color. Light emitted by the second group of light-emitting units, light emitted by the fourth group of light-emitting units, and light emitted by the sixth group of light-emitting units are the same in color. The first dichroic mirror is disposed corresponding to the first group of light-emitting units, the fourth group of light-emitting units, and the first configuration area. The second dichroic mirror is disposed corresponding to the third group of light-emitting units, the sixth group of light-emitting units, and the second configuration area. The first polarizing dichroic mirror is disposed corresponding to the second group of light-emitting units, the fourth group of light-emitting units, and the first configuration area. The second polarizing dichroic mirror is disposed corresponding to the third group of light-emitting units, the fifth group of light-emitting units, and the second configuration area. The first half-wave plate structure is disposed between the second group of light-emitting units and the first polarizing dichroic mirror or between the fourth group of light-emitting units and the first polarizing dichroic mirror. The second half-wave plate structure is disposed between the third group of light-emitting units and the second polarizing dichroic mirror or between the fifth group of light-emitting units and the second polarizing dichroic mirror. Therein, the light emitted by the first group of light-emitting units is reflected by the first dichroic mirror to reach the first configuration area. The light emitted by the second group of light-emitting units is reflected by the first polarizing dichroic mirror and passes through the first dichroic mirror to reach the first configuration area. The light emitted by the third group of light-emitting units passes through the second polarizing dichroic mirror and the second dichroic mirror to reach the second configuration area. The light emitted by the fourth group of light-emitting units passes through the first polarizing dichroic mirror and the first dichroic mirror to reach the first configuration area. The light emitted by the fifth group of light-emitting units is reflected by the second polarizing dichroic mirror and passes through the second dichroic mirror to reach the second configuration area. The light emitted by the sixth group of light-emitting units is reflected by the second dichroic mirror to reach the second configuration area. Furthermore, the light emitted by the second group of light-emitting units or the fourth group of light-emitting units passes through the first half-wave plate structure before reaching the first polarizing dichroic mirror. The light emitted by the third group of light-emitting units or the fifth group of light-emitting units passes through the second half-wave plate structure before reaching the second polarizing dichroic mirror. Thereby, the first light component and the second light component can be easily configured compactly, and the light source module can provide similar light emission compositions to the first configuration area and the second configuration area, improving the light uniformity.

Another objective of the invention is to provide a projector.

A projector of an embodiment according to the invention includes a projection lens, a light modulation module, and any of the above light source modules. Therein, the light emitted by the light source module is modulated by the light adjustment module and projected from the projector through the projection lens. Thereby, through the compact configuration of the light source module, the brightness and color uniformity of the projector can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a configuration of a light source module according to a first embodiment.

FIG. 2 is a schematic diagram of a light output configuration of the light source module in FIG. 1.

FIG. 3 is a schematic diagram showing a configuration of a light source module according to a second embodiment.

FIG. 4 is a schematic diagram of a light output configuration of the light source module in FIG. 3.

FIG. 5 is a schematic diagram showing a configuration of a light source module according to a third embodiment.

FIG. 6 is a schematic diagram of a light output configuration of the light source module in FIG. 5.

FIG. 7 is a schematic diagram showing a configuration of a projector according to a fourth embodiment.

### DETAILED DESCRIPTION

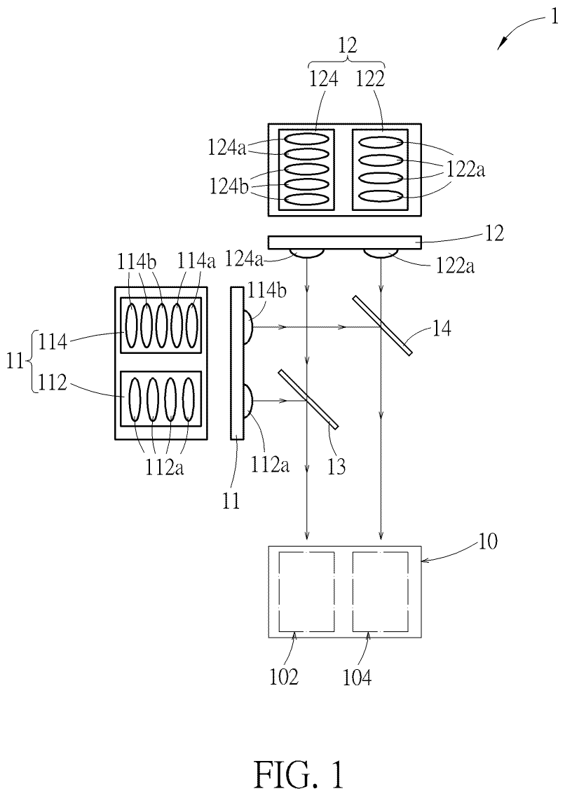

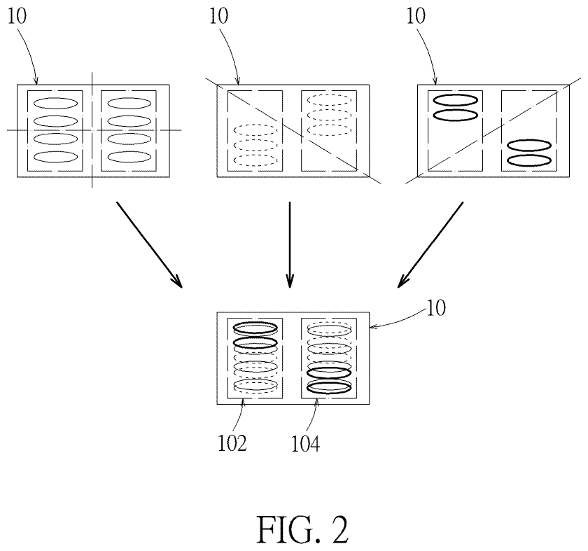

Please refer to FIG. 1 and FIG. 2. A light source module 1 according to a first embodiment includes a first light component 11, a second light component 12, a first dichroic mirror 13, and a second dichroic mirror 14. The light emitted by the first light component 11 and the second light component 12 is guided by the first dichroic mirror 13 and the second dichroic mirror 14 as the light output of the light source module 1 (its light output configuration 10 is shown in FIG. 2). The light output configuration 10 includes a first configuration area 102 and a second configuration area 104 adjacent to the first configuration area 102 (both are represented by frames in chain lines in the figures).

The first light component 11 includes a first group of light-emitting units 112 and a second group of light-emitting units 114 adjacent to the first group of light-emitting units 112, which are arranged in two parallel columns. The first group of light-emitting units 112 and the second group of light-emitting units 114 emit light of different colors (that is, the compositions of the light are different). The first group of light-emitting units 112 includes four light-emitting units (all of which are red light-emitting units 112a), arranged in a row. The second group of light-emitting units 114 includes five light-emitting units (two of which are blue light-emitting units 114a and three of which are green light-emitting units 114b), arranged in a row. The second light component 12 includes a third group of light-emitting units 122 and a fourth group of light-emitting units 124 which are arranged in two parallel columns. The third group of light-emitting units 122 and the fourth group of light-emitting units 124 emit light of different colors. The third group of light-emitting units 122 includes fourth light-emitting units (all of which are red light-emitting unit 122a), arranged in a row. The fourth group of light-emitting units 124 includes five light-emitting units (two of which are blue light-emitting units 124a and three of which are green light-emitting units 124b), arranged in a row. The first dichroic mirror 13 is disposed corresponding to the first group of light-emitting units 112, the fourth group of light-emitting units 124, and the first configuration area 102. The second dichroic mirror 14 is disposed corresponding to the second group of light-emitting units 114, the third group of light-emitting units 122, and the second configuration area 104. It should be noticed that in FIG. 1, a front view configuration diagram of the first light component 11 is shown on the left side of the first light component 11, and a front view configuration diagram of the second light component 12 is shown on the upper side of the second light component 12.

As shown by FIG. 1, the first light component 11 and the second light component 12 are structurally identical. The setting posture of the second light component 12 is rotated 180 degrees relative to the setting posture of the first light component 11 (that is, it is equivalent to compare the first light component 11 on the left side in FIG. 1 after rotated 90 degrees clockwise with the second light component 12 on the upper side in FIG. 2). Light emitted by the first group of light-emitting units 112 and light emitted by the third group of light-emitting units 122 are the same in color (that is, the compositions of the lights are the same; both are red light). Light emitted by the second group of light-emitting units 114 and light emitted by the fourth group of light-emitting units 124 are the same in color (blue and green of light). The light emitted by the first group of light-emitting units 112 is reflected by the first dichroic mirror 13 (which reflects red light and allows blue light and green light to pass through) to reach the first configuration area 102. The light emitted by the fourth group of light-emitting units 124 passes through the first dichroic mirror 13 to reach the first configuration area 102. The light emitted by the second group of light-emitting units 114 is reflected by the second dichroic mirror 14 (which reflects blue light and green light and allows red light to pass through) to reach the second configuration area 104. The light emitted by the third group of light-emitting units 122 passes through the second dichroic mirror 14 to reach the second configuration area 104.

As shown by FIG. 2, the projections of the light emitted by the light-emitting units 112a, 114a, 114b, 122a, 124a and 124b on the light output configuration 10 are represented by light spots. In the figure, the upper left picture shows red light spots (shown in thin lines); the upper middle picture shows green light spots (shown in dashed lines); the upper right picture shows blue light spots (shown in bold lines). The above three pictures are combined into the lower picture, which is the light spot distribution of light output configuration 10. The red light spots in the upper left picture are symmetrical up and down and also symmetrical left and right. The green spots in the upper middle picture are roughly symmetrical lower left and upper right. The blue light spots in the upper middle picture are roughly symmetrical upper left and lower right. In the above pictures, the symmetry axes are represented by chain lines. In addition, broadly speaking, the green spots in the upper left picture can also be read as symmetrical upper left and lower right, and so are the blue light spots in the upper right picture. In the lower picture of FIG. 2 (i.e., the light spot distribution of the light output configuration 10), the first configuration area 102 and the second configuration area 104 both include red light spots, green spots and blue light spots, so the light spot distribution of the light output configuration 10 presents relatively uniform light output compared to the light-emitting unit configuration of the first light component 11 or the second light component 12.

Furthermore, in the first embodiment, in the first light component 11, the light-emitting units 112a, 114a and 114b may be, but not limited to, laser units that emit monochromatic light. The number of the red light-emitting units 112a is greater than the number of the green light-emitting units 114b. The number of the green light-emitting units 114b is greater than the number of the blue light-emitting units 114a; however, it is not limited thereto in practice. Furthermore, in practice, the types of colored lights of the above light-emitting units 112a, 114a and 114b are not limited thereto. The above description also applies to the second light component 12, and will not be repeated in addition. Furthermore, in the first embodiment, the first light component 11 and the second light component 12 are disposed at 90 degrees (that is, the light-emitting directions of the two are perpendicular; in other words, they are disposed in an L shaped configuration), and the first dichroic mirror 13 and the second dichroic mirror 14 are disposed between the first light component 11 and the second light component 12, which is conducive to a compact structure. However, it is not limited thereto in practice.

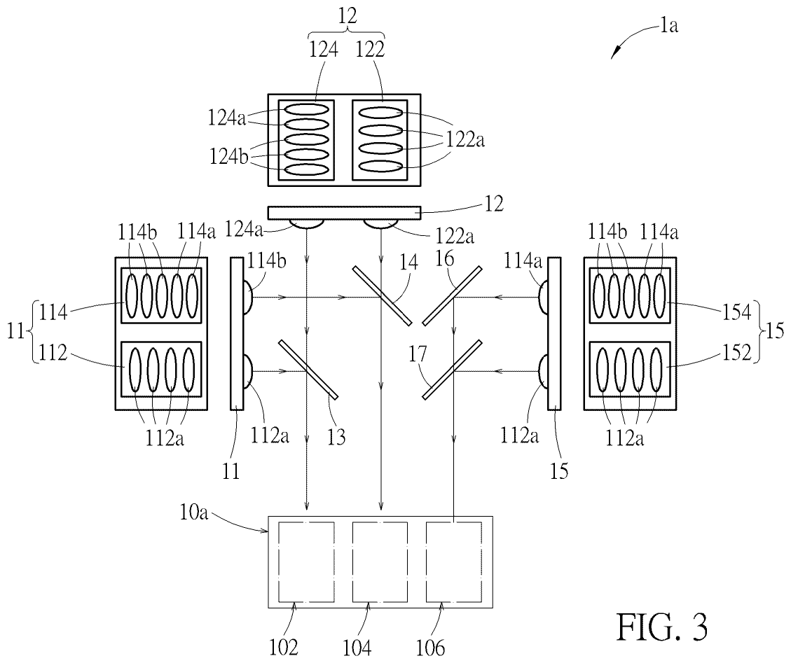

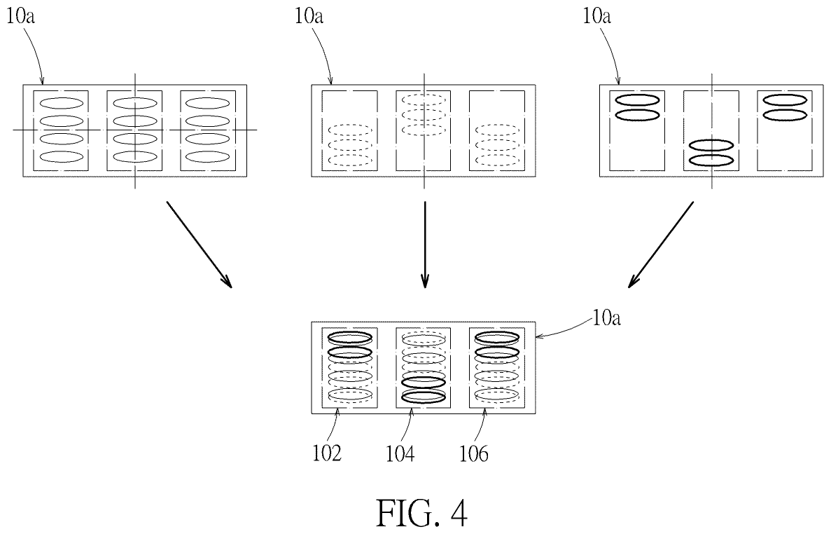

Please refer to FIG. 3 and FIG. 4. A light source module 1a according to a second embodiment is structurally similar to the light source module 1, so the light source module 1a uses the reference numbers of the light source module 1. For other descriptions above the light source module 1a, please refer directly to the relevant descriptions of light source module 1, which will not be repeated in addition. Compared with the light source module 1, the light source module 1a further includes a third light component 15, a reflection mirror 16 and a third dichroic mirror 17, and a light output configuration 10a provided by the light source module 1a further includes a third configuration area 106 (represented by a frame in chain lines in the figures). The second configuration area 104 is between the first configuration area 102 and the third configuration area 106. The third light component 15 includes a fifth group of light-emitting units 152 and a sixth group of light-emitting units 154 which are arranged in two parallel columns. Light emitted by the fifth group of light-emitting units 152 and the light emitted by the first group of light-emitting units 112 are the same in color. Light emitted by the sixth group of light-emitting units 154 and light emitted by the second group of light-emitting units 114 are the same in color. The third dichroic mirror 17 is disposed corresponding to the fifth group of light-emitting units 152 and the third configuration area 106. The reflection mirror 16 is disposed corresponding to the sixth group of light-emitting units 154 and the third configuration area 106. The light emitted by the fifth group of light-emitting units 152 is reflected by the third dichroic mirror 17 (which reflects red light and allows blue light and green light to pass through) to reach the third configuration area 106. The light emitted by the sixth group of light-emitting units 154 is reflected by the reflection mirror 16 and passes through the third dichroic mirror 17 to reach the third configuration area 106.

Therein, the third light component 15 and the first light component 11 are structurally identical. The setting posture of the third light component 15 is rotated 180 degrees relative to the setting posture of the first light component 11 (that is, it is equivalent to compare the third light component 15 on the right side in FIG. 3 after rotated 180 degrees counterclockwise with the first light component 11 on the left side in FIG. 3). The above relevant descriptions of the light-emitting units 112a, 114a and 114b of the first light component 11 (including such as the embodiment, numbers, types of colored lights, and so on of the light-emitting units) also apply to the third light component 15, and will not be repeated in addition; besides, in FIG. 3, the light-emitting units of the third light component 15 uses the reference numbers of the light-emitting units of the first light component 11 to facilitate reading of the figure. Furthermore, in the second embodiment, the first light component 11, the second light component 12, and the third light component 15 are arranged in an inverted U shape (that is, the light-emitting directions of two adjacent light components are vertical). The first dichroic mirror 13, the second dichroic mirror 14, the reflection mirror 16, and the third dichroic mirror 17 are disposed between the first light component 11, the second light component 12, and the third light component 15, which is conducive to a compact structure. However, it is not limited thereto in practice.

As shown by FIG. 4, the projections of the light emitted by the first light component 11, the second light component 12, and the third light component 15 on the light output configuration 10a are represented by light spots. In the figure, the upper left picture shows red light spots (shown in thin lines); the upper middle picture shows green light spots (shown in dashed lines); the upper right picture shows blue light spots (shown in bold lines). The above three pictures are combined into the lower picture, which is the light spot distribution of light output configuration 10a. The red light spots in the upper left picture are symmetrical up and down and also symmetrical left and right. The green spots in the upper middle picture are roughly symmetrical lower left and upper right. The blue light spots in the upper middle picture are also symmetrical left and right. In the above pictures, the symmetry axes are represented by chain lines. In the lower picture of FIG. 4 (i.e., the light spot distribution of the light output configuration 10a), the first configuration area 102, the second configuration area 104, and the third configuration area 106 all include red light spots, green spots and blue light spots, so the light spot distribution of the light output configuration 10a presents relatively uniform light output compared to the light-emitting unit configuration of the first light component 11, the second light component 12, or the third light component 15.

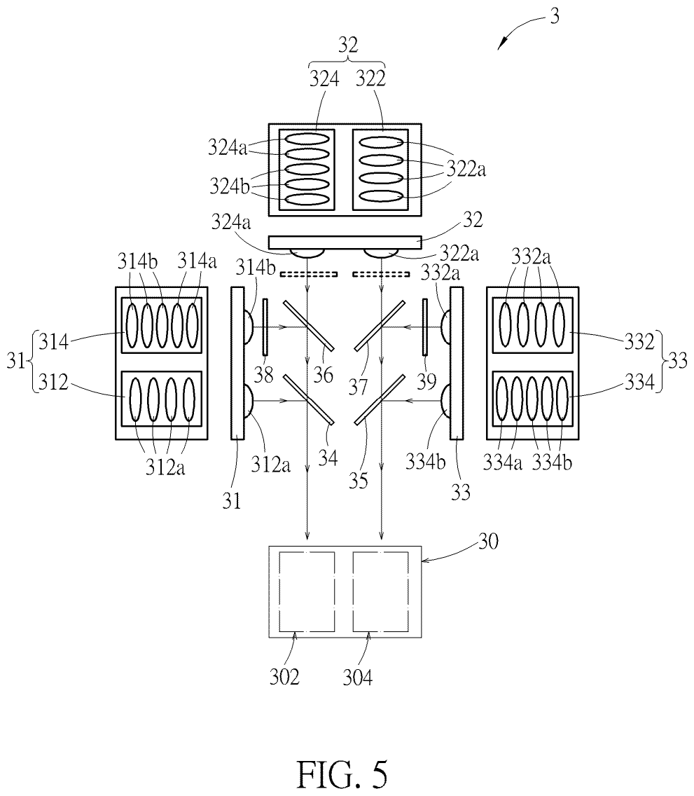

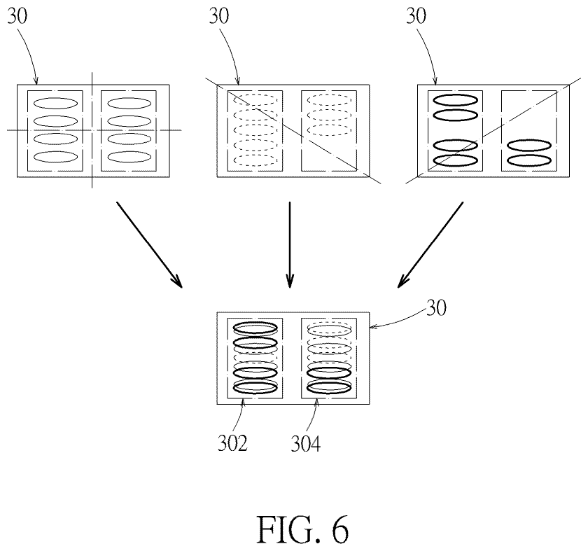

Please refer to FIG. 5 and FIG. 6. A light source module 3 according to a third embodiment includes a first light component 31, a second light component 32, a third light component 33, a first dichroic mirror 34, a second dichroic mirror 35, a first polarizing dichroic mirror 36, a second polarizing dichroic mirror 37, a first half-wave plate structure 38, and a second half-wave plate structure 39. Light emitted by the first light component 31, the second light component 32, and the third light component 33 is guided by the first dichroic mirror 34, the second dichroic mirror 35, the first polarizing dichroic mirror 36, the second polarizing dichroic mirror 37, the first half-wave plate structure 38, and the second half-wave plate structure 39 as the light output of the light source module 3 (its light output configuration 30 is shown in FIG. 6). The light output configuration 30 includes a first configuration area 302 and a second configuration area 304 adjacent to the first configuration area 302 (both are represented by frames in chain lines in the figures).

The first light component 31 includes a first group of light-emitting units 312 and a second group of light-emitting units 314 adjacent to the first group of light-emitting units 312, which are arranged in two parallel columns. The second light component 32 includes a third group of light-emitting units 322 and a fourth group of light-emitting units 324 adjacent to the third group of light-emitting units 322, which are arranged in two parallel columns. The third light component 33 includes a fifth group of light-emitting units 332 and a sixth group of light-emitting units 334 adjacent to the fifth group of light-emitting units 332, which are arranged in two parallel columns. The first group of light-emitting units 312 and the second group of light-emitting units 314 emit light of different colors (that is, the compositions of the light are different). Light emitted by the first group of light-emitting units 312, light emitted by the third group of light-emitting units 322, and light emitted by the fifth group of light-emitting units 332 are the same in color (that is, the compositions of the lights are the same; both are red light). Light emitted by the second group of light-emitting units 314, light emitted by the fourth group of light-emitting units 324, and light emitted by the sixth group of light-emitting units 334 are the same in color. Therein, the first group of light-emitting units 312 includes four light-emitting units (all of which are red light-emitting units 312a), arranged in a row. The second group of light-emitting units 314 includes five light-emitting units (two of which are blue light-emitting units 314a and three of which are green light-emitting units 314b), arranged in a row. The third group of light-emitting units 322 includes four light-emitting units (all of which are red light-emitting units 322a), arranged in a row. The fourth group of light-emitting units 324 includes five light-emitting units (two of which are blue light-emitting units 324a and three of which are green light-emitting units 324b), arranged in a row. The fifth group of light-emitting units 332 includes four light-emitting units (all of which are red light-emitting units 332a), arranged in a row. The sixth group of light-emitting units 334 includes five light-emitting units (two of which are blue light-emitting units 334a and three of which are green light-emitting units 334b), arranged in a row. It should be noticed that in FIG. 5, a front view configuration diagram of the first light component 31 is shown on the left side of the first light component 31, a front view configuration diagram of the second light component 32 is shown on the upper side of the second light component 32, and a front view configuration diagram of the third light component 33 is shown on the right side of the third light component 33.

The first dichroic mirror 34 is disposed corresponding to the first group of light-emitting units 312, the fourth group of light-emitting units 324, and the first configuration area 302. The second dichroic mirror 35 is disposed corresponding to the third group of light-emitting units 322, the sixth group of light-emitting units 334, and the second configuration area 304. The first polarizing dichroic mirror 36 is disposed corresponding to the second group of light-emitting units 314, the fourth group of light-emitting units 324, and the first configuration area 302. The second polarizing dichroic mirror 37 is disposed corresponding to the third group of light-emitting units 322, the fifth group of light-emitting units 332, and the second configuration area 304. The first half-wave plate structure 38 is disposed between the second group of light-emitting units 314 and the first polarizing dichroic mirror 36. The second half-wave plate structure 39 is disposed between the fifth group of light-emitting units 342 and the second polarizing dichroic mirror 37.

Therein, the light emitted by the first group of light-emitting units 312 is reflected by the first dichroic mirror 34 (which reflects red light and allows blue light and green light to pass through) to reach the first configuration area 302. The light (e.g., S-polarized light) emitted by the second group of light-emitting units 314 passes through the first half-wave plate structure 38 (for example, converting the S-polarized light into P-polarized light) before reaching the first polarizing dichroic mirror 36, and then is reflected by the first polarizing dichroic mirror 36 (for example, which reflects P-polarized light and allows S-polarized light to pass through) and passes through the first dichroic mirror 34 to reach the first configuration area 302. The light (e.g., S-polarized light) emitted by the third group of light-emitting units 322 passes through the second polarizing dichroic mirror 37 (for example, which reflects P-polarized light and allows S-polarized light to pass through) and the second dichroic mirror 35 (for example, which reflects blue light and green light and allows red light to pass through) to reach the second configuration area 304. The light (e.g., S-polarized light) emitted by the fourth group of light-emitting units 324 passes through the first polarizing dichroic mirror 36 and the first dichroic mirror 34 to reach the first configuration area 302. The light (e.g.,

S-polarized light) emitted by the fifth group of light-emitting units 332 passes through the second half-wave plate structure 39 (for example, converting the S-polarized light into P-polarized light) before reaching the second polarizing dichroic mirror 37, and then is reflected by the second polarizing dichroic mirror 37 and passes through the second dichroic mirror 35 to reach the second configuration area 304. The light emitted by the sixth group of light-emitting units 334 is reflected by the second dichroic mirror 35 to reach the second configuration area 304.

In practice, it is practicable to modify the first half-wave plate structure 38 to be disposed between the fourth group of light-emitting units 324 and the first polarizing dichroic mirror 36 (as shown in dashed lines in FIG. 5). In this case, the light (e.g., P-polarized light) emitted by the fourth group of light-emitting units passes through the first half-wave plate structure 38 (for example, converting the P-polarized light into S-polarized light) before reaching the first polarizing dichroic mirror 36, and then passes through the first polarizing dichroic mirror 36 (for example, which reflects P-polarized light and allows S-polarized light to pass through) and the first dichroic mirror 34 to reach the first configuration area 302; the light (e.g., P-polarized light) emitted by the second group of light-emitting units 314 is reflected by the first polarizing dichroic mirror 36 and passes through the first dichroic mirror 34 to reach the first configuration area 302. Besides, it is practicable to modify the second half-wave plate structure 39 to be disposed between the third group of light-emitting units 322 and the second polarizing dichroic mirror 37 (as shown in dashed lines in FIG. 5). In this case, the light (e.g., P-polarized light) emitted by the third group of light-emitting units 322 passes through the second half-wave plate structure 39 (for example, converting the P-polarized light into S-polarized light) before reaching the second polarizing dichroic mirror 37, and then passes through the second polarizing dichroic mirror 37 (for example, which reflects P-polarized light and allows S-polarized light to pass through) and the second dichroic mirror 35 to reach the second configuration area 304; the light (e.g., P-polarized light) emitted by the fifth group of light-emitting units 332 is reflected by the second polarizing dichroic mirror 37 and passes through the second dichroic mirror 35 to reach the second configuration area 304. In addition, if the first half-wave plate structure 38 and the second half-wave plate structure 39 are both disposed in front of the second light component 32, the first half-wave plate structure 38 and the second half-wave plate structure 39 can be structurally integrated into one piece.

In the third embodiment, the first light component 31, the second light component 32, and the third light component 33 are structurally identical. The setting posture of the second light component 32 is rotated 180 degrees relative to the setting posture of the first light component 31 (that is, it is equivalent to compare the first light component 31 on the left side in FIG. 5 after rotated 90 degrees clockwise with the second light component 32 on the upper side in FIG. 5). The setting posture of the third light component 33 is the same as the setting posture of the first light component 31 (that is, it is equivalent to compare the third light component 33 on the right side s in FIG. 5 after rotated 180 degrees counterclockwise with the first light component 31 on the left side in FIG. 5). The above relevant descriptions of the light-emitting units 112a, 114a and 114b of the first light component 11 in the first embodiment (including such as the embodiment, numbers, types of colored lights, and so on of the light-emitting units) also apply to the first light component 31, the second light component 32, and the third light component 33 in the third embodiment, and will not be repeated in addition. Furthermore, in the third embodiment, the first light component 31, the second light component 32, and the third light component 33 are arranged in an inverted U shape (that is, the light-emitting directions of two adjacent light components are vertical). The first dichroic mirror 34, the second dichroic mirror 35, the first polarizing dichroic mirror 36, the second polarizing dichroic mirror 37, the first half-wave plate structure 38, and the second half-wave plate structure 39 are disposed between the first light component 31, the second light component 32, and the third light component 33, which is conducive to a compact structure. However, it is not limited thereto in practice.

As shown by FIG. 6, the projections of the light emitted by the first light component 31, the second light component 32, and the third light component 33 on the light output configuration 30 are represented by light spots. In the figure, the upper left picture shows red light spots (shown in thin lines); the upper middle picture shows green light spots (shown in dashed lines); the upper right picture shows blue light spots (shown in bold lines). The above three pictures are combined into the lower picture, which is the light spot distribution of light output configuration 30. The red light spots in the upper left picture are symmetrical up and down and also symmetrical left and right. The green spots in the upper middle picture are roughly symmetrical lower left and upper right. The blue light spots in the upper middle picture are also symmetrical upper left and lower right. In the above pictures, the symmetry axes are represented by chain lines. In the lower picture of FIG. 6 (i.e., the light spot distribution of the light output configuration 30), the first configuration area 302 and the second configuration area 304 both include red light spots, green spots and blue light spots, so the light spot distribution of the light output configuration 30 presents relatively uniform light output compared to the light-emitting unit configuration of the first light component 31, the second light component 32, or the third light component 33.

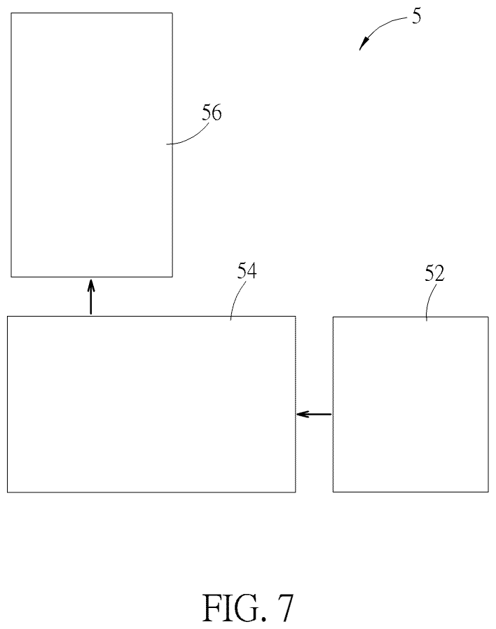

Please refer to FIG. 7. A projector 5 according to a fourth embodiment includes a light source module 52, a light modulation module 54, and a projection lens 56. Light emitted by the light source module 52 (indicated by an arrow in the figure) is modulated by the light adjustment module 54 and projected from the projector 5 through the projection lens 56. Therein, the light source module 52 can be implemented by any of the above light source modules 1, 1a and 3. Thus, through the compact configuration of the light source modules 1, 1a and 3, the brightness and color uniformity of the projector 1 can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light source module, providing a light output configuration, the light output configuration comprising a first configuration area and a second configuration area, the light source module comprising:
a first light component, the first light component comprising a first group of light-emitting units and a second group of light-emitting units;
a second light component, the second light component comprising a third group of light-emitting units and a fourth group of light-emitting units, light emitted by the first group of light-emitting units and light emitted by the third group of light-emitting units being the same in color, light emitted by the second group of light-emitting units and light emitted by the fourth group of light-emitting units being the same in color;
a first dichroic mirror, the first dichroic mirror being disposed corresponding to the first group of light-emitting units, the fourth group of light-emitting units, and the first configuration area, the light emitted by the first group of light-emitting units being reflected by the first dichroic mirror to reach the first configuration area, the light emitted by the fourth group of light-emitting units passing through the first dichroic mirror to reach the first configuration area; and
a second dichroic mirror, the second dichroic mirror being disposed corresponding to the second group of light-emitting units, the third group of light-emitting units, and the second configuration area, the light emitted by the second group of light-emitting units being reflected by the second dichroic mirror to reach the second configuration area, the light emitted by the third group of light-emitting units passing through the second dichroic mirror to reach the second configuration area.

2. The light source module according to claim 1, wherein the first group of light-emitting units and the second group of light-emitting units are arranged in two parallel columns.

3. The light source module according to claim 1, wherein the first group of light-emitting units and the second group of light-emitting units emit light of different colors.

4. The light source module according to claim 3, wherein the first group of light-emitting units comprises a plurality of red light-emitting units, and the second group of light-emitting units comprises a plurality of blue light-emitting units and a plurality of green light-emitting units.

5. The light source module according to claim 4, wherein a number of the plurality of red light-emitting units is greater than a number of the plurality of green light-emitting units, and the number of the plurality of green light-emitting units is greater than a number of the plurality of blue light-emitting units.

6. The light source module according to claim 1, wherein the first light component and the second light component are structurally identical, and a setting posture of the second light component is rotated 180 degrees relative to a setting posture of the first light component.

7. The light source module according to claim 1, wherein the light output configuration comprises a third configuration area, the second configuration area is between the first configuration area and the third configuration area, the light source module comprises a third light component, a reflection mirror, and a third dichroic mirror, the third light component comprises a fifth group of light-emitting units and a sixth group of light-emitting units, light emitted by the fifth group of light-emitting units and the light emitted by the first group of light-emitting units are the same in color, light emitted by the sixth group of light-emitting units and the light emitted by the second group of light-emitting units are the same in color, the third dichroic mirror is disposed corresponding to the fifth group of light-emitting units and the third configuration area, the reflection mirror is disposed corresponding to the sixth group of light-emitting units and the third configuration area, the light emitted by the fifth group of light-emitting units is reflected by the third dichroic mirror to reach the third configuration area, and the light emitted by the sixth group of light-emitting units is reflected by the reflection mirror and passes through the third dichroic mirror to reach the third configuration area.

8. The light source module according to claim 7, wherein the first light component and the third light component are structurally identical, and a setting posture of the third light component is rotated 180 degrees relative to a setting posture of the first light component.

9. A light source module, providing a light output configuration, the light output configuration comprising a first configuration area and a second configuration area, the light source module comprising:
a first light component, the first light component comprising a first group of light-emitting units and a second group of light-emitting units;
a second light component, the second light component comprising a third group of light-emitting units and a fourth group of light-emitting units;
a third light component, the third light component comprising a fifth group of light-emitting units and a sixth group of light-emitting units, light emitted by the first group of light-emitting units, light emitted by the third group of light-emitting units, and light emitted by the fifth group of light-emitting units being the same in color, light emitted by the second group of light-emitting units, light emitted by the fourth group of light-emitting units, and light emitted by the sixth group of light-emitting units being the same in color;
a first dichroic mirror, the first dichroic mirror being disposed corresponding to the first group of light-emitting units, the fourth group of light-emitting units, and the first configuration area;
a second dichroic mirror, the second dichroic mirror being disposed corresponding to the third group of light-emitting units, the sixth group of light-emitting units, and the second configuration area;
a first polarizing dichroic mirror, the first polarizing dichroic mirror being disposed corresponding to the second group of light-emitting units, the fourth group of light-emitting units, and the first configuration area;
a second polarizing dichroic mirror, the second polarizing dichroic mirror being disposed corresponding to the third group of light-emitting units, the fifth group of light-emitting units, and the second configuration area;
a first half-wave plate structure, the first half-wave plate structure being disposed between the second group of light-emitting units and the first polarizing dichroic mirror or between the fourth group of light-emitting units and the first polarizing dichroic mirror; and
a second half-wave plate structure, the second half-wave plate structure being disposed between the third group of light-emitting units and the second polarizing dichroic mirror or between the fifth group of light-emitting units and the second polarizing dichroic mirror;
wherein the light emitted by the first group of light-emitting units is reflected by the first dichroic mirror to reach the first configuration area, the light emitted by the second group of light-emitting units is reflected by the first polarizing dichroic mirror and passes through the first dichroic mirror to reach the first configuration area, the light emitted by the third group of light-emitting units passes through the second polarizing dichroic mirror and the second dichroic mirror to reach the second configuration area, the light emitted by the fourth group of light-emitting units passes through the first polarizing dichroic mirror and the first dichroic mirror to reach the first configuration area, the light emitted by the fifth group of light-emitting units is reflected by the second polarizing dichroic mirror and passes through the second dichroic mirror to reach the second configuration area, and the light emitted by the sixth group of light-emitting units is reflected by the second dichroic mirror to reach the second configuration area;
wherein the light emitted by the second group of light-emitting units or the fourth group of light-emitting units passes through the first half-wave plate structure before reaching the first polarizing dichroic mirror, and the light emitted by the third group of light-emitting units or the fifth group of light-emitting units passes through the second half-wave plate structure before reaching the second polarizing dichroic mirror.

10. The light source module according to claim 9, wherein the first light component, the second light component, and the third light component are structurally identical, a setting posture of the second light component is rotated 180 degrees relative to a setting posture of the first light component, and a setting posture of the third light component and the setting posture of the first light component are the same.

11. The light source module according to claim 9, wherein the first group of light-emitting units and the second group of light-emitting units are arranged in two parallel columns.

12. The light source module according to claim 9, wherein the first group of light-emitting units and the second group of light-emitting units emit light of different colors.

13. The light source module according to claim 12, wherein the first group of light-emitting units comprises a plurality of red light-emitting units, and the second group of light-emitting units comprises a plurality of blue light-emitting units and a plurality of green light-emitting units.

14. The light source module according to claim 13, wherein a number of the plurality of red light-emitting units is greater than a number of the plurality of green light-emitting units, and the number of the plurality of green light-emitting units is greater than a number of the plurality of blue light-emitting units.

15. A projector, comprising:
a light source module, providing a light output configuration, the light output configuration comprising a first configuration area and a second configuration area, the light source module comprising:
a first light component, the first light component comprising a first group of light-emitting units and a second group of light-emitting units;
a second light component, the second light component comprising a third group of light-emitting units and a fourth group of light-emitting units, light emitted by the first group of light-emitting units and light emitted by the third group of light-emitting units being the same in color, light emitted by the second group of light-emitting units and light emitted by the fourth group of light-emitting units being the same in color;
a first dichroic mirror, the first dichroic mirror being disposed corresponding to the first group of light-emitting units, the fourth group of light-emitting units, and the first configuration area, the light emitted by the first group of light-emitting units being reflected by the first dichroic mirror to reach the first configuration area, the light emitted by the fourth group of light-emitting units passing through the first dichroic mirror to reach the first configuration area; and
a second dichroic mirror, the second dichroic mirror being disposed corresponding to the second group of light-emitting units, the third group of light-emitting units, and the second configuration area, the light emitted by the second group of light-emitting units being reflected by the second dichroic mirror to reach the second configuration area, the light emitted by the third group of light-emitting units passing through the second dichroic mirror to reach the second configuration area;
a projection lens; and
a light modulation module;
wherein the light emitted by the light source module is modulated by the light adjustment module and projected from the projector through the projection lens.

16. The projector according to claim 15, wherein the first light component and the second light component are structurally identical, and a setting posture of the second light component is rotated 180 degrees relative to a setting posture of the first light component.

17. The projector according to claim 15, wherein the light output configuration comprises a third configuration area, the second configuration area is between the first configuration area and the third configuration area, the light source module comprises a third light component, a reflection mirror, and a third dichroic mirror, the third light component comprises a fifth group of light-emitting units and a sixth group of light-emitting units, light emitted by the fifth group of light-emitting units and the light emitted by the first group of light-emitting units are the same in color, light emitted by the sixth group of light-emitting units and the light emitted by the second group of light-emitting units are the same in color, the third dichroic mirror is disposed corresponding to the fifth group of light-emitting units and the third configuration area, the reflection mirror is disposed corresponding to the sixth group of light-emitting units and the third configuration area, the light emitted by the fifth group of light-emitting units is reflected by the third dichroic mirror to reach the third configuration area, and the light emitted by the sixth group of light-emitting units is reflected by the reflection mirror and passes through the third dichroic mirror to reach the third configuration area.

18. The projector according to claim 17, wherein the first light component and the third light component are structurally identical, and a setting posture of the third light component is rotated 180 degrees relative to a setting posture of the first light component.
